(19) United States
(12) Patent Application Publication
(10) Pub. No.: US 2025/0040565 A1
(43) Pub. Date: Feb. 6, 2025

(54) AERATED FAT-BASED CONFECTIONARY MATERIAL

(71) Applicant: CARGILL, INCORPORATED, Wayzata, MN (US)

(72) Inventor: Susen GOTTWALD, Frankfurt am Main (DE)

(21) Appl. No.: 18/697,178

(22) PCT Filed: Sep. 19, 2022
(86) PCT No.: PCT/US2022/076638

§ 371 Date: Mar. 29, 2024

(30) Foreign Application Priority Data
Sep. 30, 2021 (EP) 21200209.1
Apr. 12, 2022 (EP) 22168004.4

(51) Int. Cl. A23G 3/40; A23G 3/34; A23G 3/42; A23G 3/52

(52) U.S. Cl. CPC A23G 3/40; A23G 3/0012; A23G 3/42; A23G 3/52

(57) ABSTRACT

The present invention relates to the field of confectionary materials, more particular to an aerated fat-based confectionary material comprising a fat phase, a sweetener, and optionally water, wherein the fat phase is the continuous fat phase having a certain content of lauric acid, palmitic acid, and stearic acid as well as a certain content of triglycerides with a carbon number of 46 (CN46) and carbon number of 42 and 44 (CN42+CN44). The present invention moreover relates to a method of preparing said aerated fat-based confectionary material and the use thereof in confectionary products.

### CROSS-REFERENCE TO RELATED APPLICATIONS

This application claims the benefit of European Patent Application No. 21200209.1, filed 30-9-2021, and European Patent Application No. 22168004.4, filed Apr. 12, 2022, which are hereby incorporated by reference in its entirety.

### FIELD OF THE INVENTION

The present invention relates to the field of confectionary materials, more particular to an aerated fat-based confectionary material.

Aerated fat-based confectionery material has been used in confectionery products for many years. By means of aeration more pleasant textures and appearances can be obtained and the taste of the product may be improved. Examples are whipped icing and buttercream. Other types of prior art confectionary materials are e.g. whipped creams that are oil-in-water emulsions having water as the continuous phase. These whipped creams have completely different properties compared to the fat-continuous confectionary materials according to the present invention.

By the introduction of air (or another gas) the volume is increased, and the density is decreased, thereby leading to a decrease in the fat intake by consumers, which is desirable. A difficulty that has been observed with prior art aerated fat-based materials is the stability of the aerated structures within the fat, which was in the prior art either obtained by forming a rigid network of crystals in the fat phase which has a negative effect on the texture or by introduction of stabilizer systems. These stabilizer systems, such as monoglycerides, diglycerides, lactic acid or diacetyl tartaric acid are used in prior art products to enhance the whipping performance and to keep the light texture over a prolonged period of time. According to food safety regulations, it is mandatory to declare the use of any stabilizers or stabilizer systems on the ingredients list of a food product. The current market trends for food and beverages show an increased consumer awareness and interest in the ingredients; the simpler the formulation and the more understandable the ingredient information, the better. In addition, there is an increasing demand in non-hydrogenated fat solutions as well as non-palm fat solutions.

The present invention aims at providing an improved aerated fat-based confectionary material. The present invention aims at providing an aerated fat-based confectionary material without the need for stabilizers and/or emulsifiers, other than lecithin. In addition, the present invention aims to provide a non-hydrogenated and/or non-palm aerated fat-based confectionary material.

### STATEMENTS OF THE INVENTION

The present invention provides in a first aspect an aerated fat-based confectionary material comprising a fat phase, a sweetener, and optionally water, wherein the fat phase is the continuous phase, having:
a content of lauric acid (C12) in a range of from 10 to 35% by weight, preferably from 12 to 30% by weight, more preferably from 15 to 27% by weight, based on the total weight of C8-C24 fatty acids;
a content of palmitic acid and stearic acid (C16+C18) in a range of from 20 to 50% by weight, preferably from 27 to 45% by weight, more preferably from 30 to 40% by weight, based on the total weight of C8-C24 fatty acids,
a content of triglycerides with a carbon number of 46 (CN46) of from 8 to 16% by weight, preferably from 9 to 15% by weight, more preferably from 10 to 14% by weight; based on the total weight of the triglycerides; and
a content of triglycerides with a carbon number of 42 and 44 (CN42+CN44) of from 13 to 28% by weight, preferably from 14 to 27% by weight, more preferably from 15 to 26% by weight, based on the total weight of the triglycerides.

The present invention provides in a first specific aspect an aerated fat-based confectionary material having an overrun (OR %) in a range of from 30 to 90%, preferably from 45 to 85%, more preferably from 50 to 80%; and comprising a continuous fat phase and a sweetener, wherein the continuous fat phase has:
a content of lauric acid (C12) in a range of from 10 to 35% by weight, preferably from 12 to 30% by weight, more preferably from 15 to 27% by weight, based on the total weight of C8-C24 fatty acids;
a content of palmitic acid and stearic acid (C16+C18) in a range of from 20 to 50% by weight, preferably from 27 to 45% by weight, more preferably from 30 to 40% by weight, based on the total weight of C8-C24 fatty acids,
a content of triglycerides with a carbon number of 46 (CN46) of from 8 to 16% by weight, preferably from 9 to 15% by weight, more preferably from 10 to 14% by weight; based on the total weight of the triglycerides; and
a content of triglycerides with a carbon number of 42 and 44 (CN42+CN44) of from 13 to 28% by weight, preferably from 14 to 27% by weight, more preferably from 15 to 26% by weight, based on the total weight of the triglycerides.

The present invention provides in a second aspect a method of preparing an aerated fat-based confectionary material, comprising the steps of
i) providing a continuous fat phase having:
   a content of lauric acid (C12) in a range of from 10 to 35% by weight, preferably from 12 to 30% by weight, more preferably from 15 to 27% by weight, based on the total weight of C8-C24 fatty acids;
   a content of palmitic acid and stearic acid (C16+C18) in a range of from 20 to 50% by weight, preferably from 27 to 45% by weight, more preferably from 30 to 40% by weight, based on the total weight of C8-C24 fatty acids,
   a content of triglycerides with a carbon number of 46 (CN46) of from 8 to 16% by weight, preferably from 9 to 15% by weight, more preferably from 10 to 14% by weight; based on the total weight of the triglycerides;
   a content of triglycerides with a carbon number of 42 and 44 (CN42+CN44) of from 13 to 28% by weight, preferably from 14 to 27% by weight, more preferably from 15 to 26% by weight, based on the total weight of the triglycerides;
ii) mixing said continuous fat phase with a sweetener and optionally one or more additional ingredients;
iii) cooling and aerating said mixture obtained in step ii) so that an aerated fat-based confectionary material is obtained.

The present invention provides in a specific second aspect a method of preparing an aerated fat-based confectionary material, comprising the steps of
i) providing a continuous fat phase having:
   a content of lauric acid (C12) in a range of from 10 to 35% by weight, preferably from 12 to 30% by weight, more preferably from 15 to 27% by weight, based on the total weight of C8-C24 fatty acids;
   a content of palmitic acid and stearic acid (C16+C18) in a range of from 20 to 50% by weight, preferably from 27 to 45% by weight, more preferably from 30 to 40% by weight, based on the total weight of C8-C24 fatty acids,
   a content of triglycerides with a carbon number of 46 (CN46) of from 8 to 16% by weight, preferably from 9 to 15% by weight, more preferably from 10 to 14% by weight; based on the total weight of the triglycerides;
   a content of triglycerides with a carbon number of 42 and 44 (CN42+CN44) of from 13 to 28% by weight, preferably from 14 to 27% by weight, more preferably from 15 to 26% by weight, based on the total weight of the triglycerides;
ii) mixing said continuous fat phase with a sweetener and optionally one or more additional ingredients;
iii) cooling and aerating said mixture obtained in step ii) so that an aerated fat-based confectionary material is obtained having an overrun (OR %) in a range of from 30 to 90%, preferably from 45 to 85%, more preferably from 50 to 80%.

The present invention provides in a third aspect a confectionary product comprising the aerated fat-based confectionary material according to the invention or prepared according to the method of the invention.

### DETAILED DESCRIPTION

The present invention relates to an aerated fat-based confectionary material comprising a continuous fat phase having:
a content of lauric acid (C12) in a range of from 10 to 35% by weight, based on the total weight of C8-C24 fatty acids;
a content of palmitic acid and stearic acid (C16+C18) in a range of from 20 to 50% by weight, based on the total weight of C8-C24 fatty acids,
a content of triglycerides with a carbon number of 46 (CN46) of from 8 to 16% by weight, based on the total weight of the triglycerides; and
a content of triglycerides with a carbon number of 42 and 44 (CN42+CN44) of from 13 to 28% by weight, based on the total weight of the triglycerides.

The aerated fat-based confectionary material comprising a continuous fat phase, meaning that the aerated fat-based confectionary material comprising a fat phase, a sweetener, and optionally water, wherein the fat phase is the continuous phase.

The fat phase in the present confectionary material is the continuous phase. In case water is present, the confectionary material is a so-called water-in-fat-emulsion (also called water in oil or W/O) in which fat is the continuous phase (also called dispersion medium) and water is the dispersed phase. Such an emulsion has completely different properties as fat-in-water emulsions (also called oil in water or O/W), such as whipped cream, in which water is the continuous phase (dispersion medium) and fat is the dispersed phase. These two types of emulsions cannot be compared in view of properties since they differ remarkedly in chemical nature, e.g. O/W are mixable with water, non-greasy, and will absorb water, whereas W/O mix easily with oils and allow have high oil concentrations. With the present invention it has been succeeded in obtaining a W/O emulsion wherein the continuous fat phase allows good aeration.

In a specific aspect, the invention relates to an aerated fat-based confectionary material comprising: a) from 40 to 70% by weight of a continuous fat phase; b) from 20 to 50% by weight of a sweetener, preferably icing sugar or glucose sirup; from 5 to 20% by weight of an aqueous solution or dispersions, preferably water; and from 0.3 to 1.0% by weight of lecithin; wherein the amounts are based on the weight of the aerated fat-based confectionary material; wherein said aerated fat-based confectionary material has an overrun (OR %) in a range of from 30 to 90%, preferably from 45 to 85%, more preferably from 50 to 80%, even more preferably from 55 to 75%. This specific aspect may comprise up to 25% by weight of additional ingredients, based on the weight of the aerated fat-based confectionary material. The combined amounts of a), b), c), d) and optional additional ingredients amounts to 100% by weight.

Because of the specific continuous fat phase of the confectionary material according to the invention, the continuous fat phase once aerated shows improved aeration compared to confectionary materials having a different composition. For example, compared to compositions comprising more C12 and less C16+C18 fatty acids or vice versa or having triglycerides with different carbon numbers than claimed.

The present confectionary material achieves one or more of the above cited aims. The present continuous fat phase having the selected features may provide a confectionary material having a light and creamy texture and a good balance between stability and hardness. The specific selection of the continuous fat phase provides the benefits of the present invention, such as an excellent aeration capacity, allowing to obtain the low density confectionary materials of the invention.

### The Continuous Fat Phase

### Fatty Acid Profile

The continuous fat phase of the aerated fat-based confectionary material of the present invention has a specific fatty acid profile. With fatty acid profile as used in the present description is meant the percentages of fatty acids that are bound as acyl groups in the (tri)glycerides forming the continuous fat phase. The fatty acid profile is determined by standard techniques, such as fatty acid methyl ester (FAME) analysis using gas chromatography according to AOCS method Cel-62. The % of fatty acid residues discussed in this description are based on the total weight of all C8 to C24 fatty acids, both saturated as well as unsaturated.

The continuous fat phase of the aerated fat-based confectionary material according to the present invention has a lauric acid (C12) content in a range of from 10 to 35%, preferably from 12 to 30%, more preferably from 15 to 27%. The lauric fatty acids of the confectionary material of the present invention may be sourced from a lauric fat. A lauric fat is meant a fat that is rich in saturated fatty acids with a carbon chain length of 12 and 14 (C12 and C14). Examples of lauric fat are, but are not limited to, coconut oil, fully hydrogenated coconut oil, palm kernel oil, fully or partially hydrogenated palm kernel oil, palm kernel stearin, fully hydrogenated palm kernel stearin, palm kernel olein, fully or partially hydrogenated palm kernel olein, or a mixture of two or more thereof. Preferably, the lauric fatty acids are sourced from coconut oil, fully hydrogenated coconut oil, both being non-palm oils.

The continuous fat phase of the aerated fat-based confectionary material according to the present invention has a combined palmitic acid and stearic acid (C16+C18) content of in a range of from 20 to 50%, preferably from 27 to 45%, more preferably from 30 to 40%. The saturated C16+C18 fatty acids of the confectionary material of the present invention may be sourced from non-lauric fats. Examples of non-lauric fat are, but are not limited to, palm oil, cocoa butter and fractions thereof, shea butter, shea stearin, shea olein, fully hydrogenated vegetable liquid oils, or any combination of two or more thereof. The triglycerides may be hydrogenated and/or fractionated. Palm oil is encompassing palm oil, as well as palm oil fractions such as stearin and olein fractions (single as well as double fractionated), palm mid fractions and blends of palm oil and/or its fractions. Vegetable liquid oils are oils having a melting point of 20° C. or lower and may be selected from the group consisting of sunflower oil, rapeseed oil, soybean oil, cottonseed oil, corn oil or a combination of two or more thereof.

In a preferred aspect, the continuous fat phase of the aerated fat-based confectionary material according to the present invention may have a ratio of C16 over C18 (C16/C18) of at most (maximally) 1.2, preferably at most 1.1, more preferably at most 1.0. With ratio of C16 over C18 or C16/C18 is meant the ratio between saturated C16 fatty acid residues divided by saturated C18 fatty acid residues. Fatty acids having a ratio of C16/C18 of at most 1.2 may be sourced from cocoa butter, shea butter, shea stearin, shea olein, and fully hydrogenated vegetable liquid oils. Typically, fatty acids having a ratio of C16/C18 of at most 1.2 are not sourced from palm oil.

In another preferred aspect, the continuous fat phase of the aerated fat-based confectionary material according to the present invention may have a ratio of palmitic acid over stearic acid (C16/C18) of minimally 0.5, minimally 0.6, minimally 0.7.

In a more preferred aspect of the invention, the continuous fat phase of the aerated fat-based confectionary material according to the present invention has a C16/C18 ratio in a range of from 0.5 to 1.2, from 0.6 to 1.1, or from 0.7 to 1.0. Fatty acids having a ratio of C16/C18 of at least 0.5 and at most 1.2 may be sourced from cocoa butter.

In another aspect, the continuous fat phase of the aerated fat-based confectionary material according to the present invention has a combined unsaturated C18 fatty acids content (unsaturated C18 content) in a range of from 15 to 40% by weight, preferably from 18 to 37% by weight, more preferably from 20 to 34% by weight, based on the total weight of C8-C24 fatty acids. With combined unsaturated C18 content is meant the total of all C18 fatty acid residues with at least one unsaturated carbon-carbon bond, viz. C18:1+C18:2+C18:3. Examples of vegetable liquid oils being a suitable source of unsaturated C18 fatty acids are, amongst others, double fractionated palm olein, cottonseed oil, corn oil, groundnut oil, linseed oil, olive oil, rapeseed oil, rice bran oil, sesame oil, safflower oil, soybean oil, sunflower oil, oil from any variety of oilseeds with increased level of unsaturated fatty acids compared to the original seed variety, such as mid or high oleic sunflower oil. These varieties with increased levels of unsaturated fatty acids can be obtained by natural selection or by genetic modification (GMO). Preferably, fatty acids having a combined unsaturated C18 content in a range of from 15 to 40% are sourced from vegetable liquid oils selected from the group consisting of cottonseed oil, corn oil, groundnut oil, linseed oil, olive oil, rapeseed oil, rice bran oil, sesame oil, safflower oil, soybean oil, sunflower oil, their corresponding high oleic varieties, and mixture of two or more thereof. More preferably, fatty acids having a combined unsaturated C18 content of from 15 to 40% are sourced from vegetable liquid oils selected from the group consisting of corn oil, rapeseed oil, soybean oil, sunflower oil, their corresponding high oleic varieties, and mixture of two or more thereof. The high oleic varieties are containing at least 40%, at least 50%, at least 60%, at least 70% and preferably at least 80% oleic acid in respect of the fatty acid profile

The confectionary material according to the present invention may have the following fatty acid profile:
C12 in a range of from 12 to 30% by weight;
C16+C18 in range of from 27 to 45% by weight;
C16/C18 ratio of at most 1.2;
unsaturated C18 in a range of from 18 to 37% by weight.

The confectionary material according to the present invention may have the following fatty acid profile:
C12 in a range of from 15 to 27% by weight;
C16+C18 in a range of from 30 to 40% by weight;
C16/C18 ratio of from 0.5 to 1.2;
unsaturated C18 in arrange of from 20 to 34% by weight.

The continuous fat phase may contain more than 95% by weight (for example more than 98% by weight, for further example more than 99% by weight) of fatty acids have a carbon chain length less than 22, based on the weight of the continuous fat phase.

### Carbon Number

The continuous fat phase of the aerated fat-based confectionary material is further characterized by a content of triglycerides with a carbon number of 46 (CN46) and by a combined content of triglycerides with a carbon number 42 and 44 (CN42+44). CN measurements measure the triglyceride content based on molecular weight differences and indicating the total carbon atoms in the three acyl chains residues. The notation triglyceride CNxx denotes triglycerides having xx carbon atoms in the fatty acyl groups e.g. CN54 includes tristearin. These measurements are carried out using standard procedure for analyzing triglyceride composition of fats, such as according to the AOCS Official Method Ce 5-86, using based on gas chromatography (GC), or Ce 5b-89 based on high-pressure liquid chromatography (HPLC). Amounts of triglycerides specified with each carbon number (CN), as is customary terminology in the art, are percentages by weight based on total triglycerides of CN26 to CN62 present in the fat composition.

The continuous fat phase of the aerated fat-based confectionary material according to the present invention has a content of triglycerides with a carbon number of 46 (CN46) of from 8 to 16% by weight, preferably from 9 to 15% by weight, more preferably from 10 to 14% by weight; and a content of triglycerides with a carbon number of 42 and 44 (CN42+CN44) of from 13 to 28% by weight, preferably from 14 to 27% by weight, more preferably from 15 to 26% by weight.

### Interesterified Fats

The continuous fat phase of the aerated fat-based confectionary material according to the present invention having a fatty acid composition as specified and having a CN46 of from 8 to 16% by weight and a CN42+CN44 from 13 to 28% by weight may be obtained by the use of one or more interesterified fats. An interesterified fat is a fat composition that has been subjected to interesterification. The values for CN46 and CN42+CN44 are indicative of the continuous fat phase according to the present invention comprising an interesterified fat.

Interesterification is a process which redistributes the fatty acid acyl residues on the triglyceride molecules in a random fashion. It is sometimes called randomization. An interesterified fat is a fat composition wherein the fatty acids have been redistributed over the glyceride backbone of said triglycerides.

In a preferred aspect, one or more interesterified fats may form part of the continuous fat phase of the aerated fat-based confectionary material according to the present invention. One or more other fats (e.g. liquid oils) may be present in addition to the one or more interesterified fats.

The amount of interesterified fat in the continuous fat phase of the aerated fat-based confectionary material may range from 70 to 100% by weight, based on the weight of the continuous fat phase, preferably at least 80% by weight, such as at least 85% by weight, such as at least 90% by weight, such as at least 95% by weight, such as at least 99% by weight. The remainder being one or more other non-interesterified fats, such as liquid oils.

In another preferred aspect, the continuous fat phase of the aerated fat-based confectionary material may also be fully formed of one or more interesterified fats having the claimed fatty acid composition. In such an aspect, the continuous fat phase of the aerated fat-based confectionary material according to the present invention consists of one or more interesterified fats, being 100% by weight of interesterified fat, based on the weight of the continuous fat phase. The one or more interesterified fats in this aspect comply with the fatty acid profile and carbon number as specified in claim 1.

### Process of Interesterification

An interesterified fat can be obtained by means of a process of chemical or enzymatic interesterification, which are known to a person skilled in the art. The present aerated fat-based confectionary material has a continuous fat phase which may comprise at least one chemically or enzymatically interesterified fat that complies with the claimed ranges.

A chemical interesterification is performed by using an acidic or basic catalyst, preferably a basic catalyst, such as, but not limited to, sodium methoxide or sodium ethoxide. An enzymatic interesterification is obtained by means of a lipase enzyme. The lipase will generally be non-selective for the positions on the glyceride backbone in order to achieve the optimum random interesterification. Alternatively, selective lipases may be used, provided that the reaction conditions are such that no significant selectivity is observed, for example by running the reaction for extended periods of time. Suitable lipases include the lipases from Thermomyces lanuginosa, Rhizomucor miehei, Rhizopus delemar and Candida rugosa. Preferably, the lipase is suitable for use with food products. Preferably, the one or more interesterified fats are obtained by means of a chemical interesterification.

The interesterified fat may have a ratio of symmetrical triglycerides to asymmetrical triglycerides in a range of from 0.90 to 1.10, from 0.95 to 1.05.

The interesterified fat may be obtained by interesterifying a starting fat composition, preferably a starting fat composition comprising at least two fats, e.g. a lauric fat and a non-lauric fat and optionally in addition a vegetable oil. Interesterified fat of said starting fat composition will usually have CN distributed in a Gaussian profile, centered around CN46.

The starting fat composition may comprise lauric fat in an amount of from 30 to 70% by weight based on the weight of the starting fat composition. The starting fat composition may comprise non-lauric fat in an amount of from 30 to 70% by weight based on the weight of the starting fat composition. The starting fat composition may comprise as part of the non-lauric fat a vegetable oil in an amount of from 10 to 25% by weight based on the weight of the starting fat composition.

### Solid Fat Content

The continuous fat phase of the aerated fat-based confectionary material has a certain solid fat content (SFC) profile against temperature. This is measured according to standard methods, according to AOCS Cd 16b-93.

In one aspect of the invention, the aerated fat-based confectionary material has an SFC value at 20° C. (N20 value) of above 27%, preferably from 27 to 45%, and an SFC value at 35° C. (N35 value) of below 7%, preferably from 0 to 5%.

In a preferred aspect of the invention, the continuous fat phase of the aerated fat-based confectionary material has an SFC value:
at 10° C. (N10 value) of from 50 to 75%; preferably from 55 to 70%;
at 20° C. (N20 value) of above 27%, preferably from 27 to 45%;
at 25° C. (N25 value) of from 15 to 30%; preferably from 17 to 28%;
at 30° C. (N30 value) of from 5 to 15%; preferably from 7 to 13%;
at 35° C. (N35 value) of below 7%, preferably from 0 to 5%; and
at 40° C. (N40 value) of below 2%, preferably from 0 to 1%.

The continuous fat phase according to the present invention may have a difference (delta) between N25 and N30 (N25 minus N30) of from 9 to 13, preferably from 8 to 12. The continuous fat phase according to the present invention may have a difference (delta) between N20 and N25 (N20 minus N25) of from 12 to 16, preferably from 11 to 15.

This level of steepness allows the fat crystals to stabilize the incorporated gas bubbles and fix these into the crystal network formed by the fat and sugar.

### Amount of Continuous Fat Phase

The continuous fat phase may be present in a range of from 25 to 80% by weight, preferably from 30 to 75% by weight, based on the weight of the confectionary material. Without wishing to be bound to a particular theory, the continuous fat phase has the function of providing a smooth, rich texture and in addition acts as a flavor carrier and a binder; in addition to the sweetener (discussed below) it is the main component of the confectionary material.

Non-Palm and/or Non-Hydrogenated Fats

The fats used in the aerated fat-based confectionary material may all be non-palm fats to provide a non-palm aerated fat-based confectionary material.

The fats used in the fat-based confectionary material may all be non-hydrogenated fats to provide a non-hydrogenated aerated fat-based confectionary material. In other words, the continuous fat phase in the fat-based confectionary material may consist of non-hydrogenated fats. With non-hydrogenated is meant that the fats in the confectionary material have not been subjected to a hydrogenation process to convert unsaturated fatty acids residues into saturated fatty acid residues. The fats used in the fat-based confectionary material may all be non-palm non-hydrogenated fats to provide a non-palm non-hydrogenated aerated fat-based confectionary material.

### Preferred Aspects of the Continuous Fat Phase

The confectionary material may have a continuous fat phase having:
a content of lauric acid (C12) in a range of from 12 to 30% by weight, based on the total weight of C8-C24 fatty acids;
a content of palmitic acid and stearic acid (C16+C18) in a range of from 27 to 45% by weight, based on the total weight of C8-C24 fatty acids;
a ratio of a ratio of palmitic acid over stearic acid (C16/C18) of at most 1.2;
a content of triglycerides with a carbon number of 46 (CN46) of from 9 to 15% by weight, based on the total weight of the triglycerides; and
a content of triglycerides with a carbon number of 42 and 44 (CN42+CN4) of from 14 to 27% by weight, based on the total weight of the triglycerides.

The confectionary material may have a continuous fat phase having:
a content of lauric acid (C12) in a range of 15 to 27% by weight, based on the total weight of C8-C24 fatty acids;
a content of palmitic acid and stearic acid (C16+C18) in a range of from 30 to 40% by weight, based on the total weight of C8-C24 fatty acids;
a ratio of a ratio of palmitic acid over stearic acid (C16/C18) in a range of from 0.5 to 1.2;
a content of triglycerides with a carbon number of 46 (CN46) of from 10 to 14% by weight; based on the total weight of the triglycerides; and
a content of triglycerides with a carbon number of 42 and 44 (CN42+CN4) of from 15 to 26% by weight, based on the total weight of the triglycerides.

### Sweetener

The confectionary material according to the present invention comprises a sweetener which imparts taste to the confectionary product and has an effect on the texture thereof.

The sweetener may be selected from the group consisting of monosaccharides (e.g. glucose/dextrose, fructose, mannose, galactose, or xylose), disaccharides (e.g. sucrose/saccharose, lactose, maltose, isomaltulose), polyols (sorbitol, mannitol, maltitol, xylitol, erythritol, or isomalt), high intensity sweeteners (e.g. Stevia® with steviol glycosides as active compounds); honey, agave syrup, maple syrup, and combinations of two or more thereof.

The sweetener may be sucrose in the form of table sugar, powdered sugar, caster sugar, icing sugar, sugar syrup, silk sugar, unrefined sugar, raw sugar cane, and molasses. The sweetener may be icing sugar or silk sugar. The particle size of sugar may determine to a significant extent the mouthfeel and the pleasantness of eating the confectionary material. A lower particle size (powdered sugar or even silk sugar) increases the pleasantness of eating the confectionary material. The sugar may be milled during the preparation or may be commercially obtained. The specific surface area increases for smaller particle size of the sugar crystals. With icing sugar in the present description is meant a granular sucrose having a granulometry such that at least 90% by weight of the sucrose granules having a particle size of less than 0.14 mm and having at most 0.5% by weight of the sucrose granules having a particle size of more than 0.25 mm. With silk sugar in the present description is meant a granular sucrose having a granulometry such that at least 90% by weight of the sucrose granules having a particle size of in a range of from 5 to 35 micrometer. The particle size of silk sugar is significant smaller than that of icing sugar; the surface area is significantly larger resulting in a more viscous confectionary material.

Some or all of the sugar may be replaced by less sweet sugars such as dextrose or other low molecular weight carbohydrates such as dry glucose syrup (DGS) powders or with maltodextrins to provide bulkiness, each of these has one important common property: to be water soluble and therefore to dissolve in the mouth when the confectionary material is consumed.

The sweetener may be present in an amount of from 20 to 75% by weight, or from 25 to 70% by weight, based on the total weight of the aerated fat-based confectionary material.

The aerated fat-based confectionary material may comprise from 25 to 80% by weight or from 30 and 75% by weight of the continuous fat phase and from 20 to 75% by weight or from 25 to 70% by weight of the sweetener, based on the total weight of the aerated fat-based confectionary material.

### Aeration

The level of aeration of the aerated fat-based confectionary material is characterized by the overrun expressed in percentage (% OR). Overrun represents the gas that is added and is equivalent to the volume of gas (e.g. air) per unit volume of gas-free material (non-aerated fat-based confectionary material).

The aerated fat-based confectionary material has a % OR in a range of from 30 to 90%, preferably from 45 to 85%, more preferably from 50 to 80%, most preferably from 55 to 75%. An overrun in this range provides optimal texture/mouthfeel and taste while having the required stability.

The overrun may be determined by weighing the fat-based confectionary material prior to aeration and after aeration in a same recipient, having the same fixed volume and then calculation the overrun based on the formula below. The overrun is determined by weighting the samples at 20° C. and under atmospheric pressure. For the same fixed volume the following equation applies:

$$overrun = 100 \times \frac{\begin{matrix}( ( weight of material before aeration ) - \\ ( weight of material after aeration ) )\end{matrix}}{( weight of material after aeration )}$$

The confectionary material according to the present invention is an aerated confectionary material, in other words a fat-based confectionary material that has been subjected to aeration using a gas. The fat forms the continuous phase and the gas forms small bubbles within said fat-continuous phase. Aeration can be done with air or another food-safe gas, such as nitrogen or carbon dioxide. In an aspect, aeration is carried out by mixing at a speed of above 150 rpm, such as from 150 to 400 rpm, preferably above 200 rpm, such as from 200 and 350 rpm, e.g. 300 rpm. In an aspect, the gas (e.g. air) is injected in the mixture. In an aspect, gas is injected into the mixture with a pressure of at least 1 bar, preferably of from 1.2 to 1.6 bar, such as at 1.5 bar. In a specific aspect, the cooled mixture is aerated by mixing at a speed of at least 200 rpm (such as 220 rpm) and injecting air at a pressure of from 1.2 to 1.6 bar. When a gas is introduced into the fat-based confectionary material, the density of said confectionary material decreases. In addition, the texture and viscosity changes. The amount of aeration can therefore be expressed by means of the percentage overrun of the confectionary material.

In a preferred aspect, the aerated fat-based confectionary material according to the present invention has a hardness increase between day 1 and day 21 that is at most 70%, preferably at most 60%, such as at most 50%.

### Additional Ingredients

In an aspect of the present invention, the confectionary material is a water-in-oil emulsion and an aqueous solution or dispersion (comprising water) is present in an amount of up to 20%, up to 10%, or up to 8% by weight based on the weight of the confectionary material, such as from 0.5 to 10.0% by weight, preferably from 1.0 to 5.0% by weight. The aqueous solution or dispersion may be water or milk or other water-comprising solutions or dispersions. For the preparation of the aerated fat-based confectionary material the continuous fat phase can be mixed with a water phase, optionally in which other ingredients (e.g. sweetener and/or other ingredients) are dissolved and/or dispersed. For sufficient emulsification an emulsifier, e.g. lecithin, may be added and/or a homogenization step may be applied.

The aerated fat-based confectionary material may comprise:
a) from 40 to 70% by weight of the continuous fat phase as described before;
b) from 20 to 50% by weight of a sweetener, preferably icing sugar or glucose syrup;
c) from 0.5 to 8% by weight of an aqueous solution or dispersions, preferably water; and
d) from 0.3 to 1.0% by weight of lecithin;
   wherein the amounts are based on the weight of the aerated fat-based confectionary material; and
   wherein said aerated fat-based confectionary material has an overrun (OR %) in a range of from 30 to 90%, preferably from 45 to 85%, more preferably from 50 to 80%.

The fat-based confectionary material may also be substantially free of water, e.g. comprising water in an amount of less than 0.1% by weight, based on the weight of the confectionary material. This can for example be beneficial if the confectionary material is to be used in sandwich applications or as confectionary material for cookies or wafers. This allows an airy confectionary material to be used without the risk of sogginess for the cookie or wafer.

The confectionary material may comprise one or more additional ingredients, selected from the group consisting of milk ingredients, milk alternative ingredients, egg ingredients, cocoa ingredients, fruit ingredients, coffee powder, nut paste (e.g. peanut butter, almond butter etc.), natural colorants, synthetic colorants, salt, antioxidants, emulsifiers, natural flavors, synthetic flavors, and a combination of two of more thereof. Milk ingredients may be full or skimmed milk (powder), cream, whey (powder), yoghurt (powder) or lactose. Milk alternative ingredients may be rice milk powder, coconut milk powder or the like. Fruit ingredients may amongst others be fruit paste, jam, dried fruit. As emulsifier, lecithin may be used. In an aspect, no emulsifier selected from the group consisting of mono- and diglycerides of lactic acid and/or diacetyl tartaric acid is present. In an aspect, as emulsifier a lecithin is present, preferably a sunflower and/or soy lecithin, in an amount of from 0.1 to 1.0% by weight, such as from 0.4 to 0.6% by weight, based on the total weight of the aerated fat-based confectionary material.

The confectionary material may comprise (small) particulate inclusions, such as chopped nuts, chocolate (dark, milk and/or white) pieces, dried fruit pieces, cereal crisps or one or more combinations thereof.

### Process for Preparing Confectionary Materials

The present invention relates in an aspect to method of preparing an aerated fat-based confectionary material, comprising the steps of
i) providing a continuous fat phase having:
   a content of lauric acid (C12) in a range of from 10 to 35% by weight, preferably from 12 to 30% by weight, more preferably from 15 to 27% by weight, based on the total weight of C8-C24 fatty acids;
   a content of palmitic acid and stearic acid (C16+C18) in a range of from 20 to 50% by weight, preferably from 27 to 45% by weight, more preferably from 30 to 40% by weight, based on the total weight of C8-C24 fatty acids,
   a content of triglycerides with a carbon number of 46 (CN46) of from 8 to 16% by weight, preferably from 9 to 15% by weight, more preferably from 10 to 14% by weight; based on the total weight of the triglycerides;
   a content of triglycerides with a carbon number of 42 and 44 (CN42+CN4) of from 13 to 28% by weight, preferably from 14 to 27% by weight, more preferably from 15 to 26% by weight, based on the total weight of the triglycerides;
ii) mixing said continuous fat phase with a sweetener and optionally one or more additional ingredients;
iii) cooling and aerating said mixture obtained in step ii) so that an aerated fat-based confectionary material is obtained, preferably having an overrun (OR %) in a range of from 30 to 90%, more preferably from 45 to 85%, most preferably from 50 to 80%.
   Step i) of the method may comprise two sub steps i-a) and i-b). Step i-a) being the blending of at least one lauric fat and at least one non-lauric fat to provide a fat composition; and step i-b) being the interesterification of said fat composition to obtain an interesterified fat. The interesterification may be enzymatic of chemical interesterification. An additional step may be present of blending one or more other fats that are non-interesterified fats with the interesterified fat(s). These one or more other fats (such as liquid oil) may be blended to the one or more interesterified fats after the step of interesterification.
   Step ii) of the method includes mixing of the ingredients. These ingredients may be mixed at a temperature of at least 40° C., preferably at least 45° C. Maximum temperatures may be determined based on the composition and may be for example at most 70° C. or 60° C. Mixing at this temperature will ensure optimal results for mixing. This temperature may be obtained by the use of a mixing device that is temperature controlled, preferably by means of a double wall filled with a heating agent, such as water.
   Step iii) comprises the cooling of the mixture obtained in step ii). Prior to and/or during aeration, the mixture obtained in step ii) is cooled to the crystallization temperature. This crystallization temperature depends on the fat composition and can be in a range of from 20 and 35° C. The cooling ensures that the best possible aeration is achieved. If the temperature during aeration is too low or too high, less gas (e.g. air) can be incorporated into the fat composition leading to a too low overrun. This temperature may be obtained by the use of a mixing device that is temperature controlled, preferably by means of a double wall filled with a cooling agent, such as water.

The confectionary materials may be prepared using conventional techniques and apparatuses for blending, interesterification, mixing and aeration that are known to a person skilled in the art.

### Confectionary Products

In an aspect, the invention relates to a confectionary product comprising the aerated fat-based confectionary material, preferably wherein said confectionary product is selected from the group consisting of biscuits, cakes and cupcakes, sandwich cookies, wafers, filled chocolate tablets, fondants, truffles, caramels and pralines.

Confectionary materials are key ingredients and incorporated into, or applied as decoration onto a variety of confectionary products, such as pastries and desserts such as donuts, layer cakes, eclairs, pies, turnovers, sandwich-cookies or savory baked goods to impart unique color, taste, and texture. Aerated fat-based confectionary materials have light, aerated textures and it is beneficial that these textures are stable over time. They may be used as filling, such as a filling cream, decoration, topping, icing, frosting etc.

The fat-based confectionary material of the invention was found to be particular suitable as ingredient for bakery applications and confectionary applications. The confectionary materials according to the invention have excellent taste and texture properties as well as excellent physical properties, stability and provide good sensory performance.

The aerated fat-based confectionery material may be a cream or spread (e.g. for applying to bread optionally containing chocolate and/or hazelnuts), a coating (e.g. applied by enrobing, dipping, moulding, panning or spraying), an inclusion (partly enclosed in a confectionary component such as a core of a praline or ice cream), a topping (soft foam on desert, drink, cake) or as icing of butter cream (for cupcake or cake) or as a filling, to fill a praline, shell-moulded chocolate, a (sandwich) cookie, a cake or cupcake, a (sandwich) biscuit, or a wafer or a cereal tube or pillow.

In the bakery field cookies and/or wafers in combination with other products are plentiful, such flat wafers filled with low moisture (aerated) sugar-fat creams to form sandwiches or hollow wafer bars or pralines filled with an (aerated) cream confectionary material. Filled sandwiches (either with cookies or wafers) exist in many types, shapes and flavors and there is an ever increasing demand for moisture-free (aerated) sweet-fat cream confectionary materials that are e.g. non-hydrogenated and/or non-palm. Sugar-fat creams are known in several variations of flavor and color. For these filled applications it is important that the confectionary materials are low in moisture in order to ensure the confectionary material keeps the wafers/cookies crisp; the present invention may relate to a confectionary material having a moisture content in a range of from 0.5 to 0.8%.

The sweetener is an essential part of the taste of these filled wafers and the melting properties of the fat-based confectionary material is essential for eating quality. For these flat wafer cookies which are stored often at room temperature, the structural stability in time of the confectionary material is very important to avoid any flowing out of the confectionary material or any hardening in texture which will decrease the pleasant mouthfeel. The density of non-aerated fat-based confectionary materials is usually about 1.25 grams per cm³. For aerated fat-based confectionary materials it is desirable to have a reduced density in the range of from 0.8 to 0.95 grams per cm³. The present invention allows a good stability of these aerated confectionary materials by virtue of the specific selection of fat characterized by the carbon numbers and having a specific fatty acid profile. The aerated confectionary material has a soft paste-like texture that after cooling provides a more solid, stable state that allows the processing of the confectionary product. The amount of confectionary material in the confectionary product may vary but is for example in a range of from 65 to 82% by weight on basis of the total weigh of the confectionary product for a filled sandwich wafer product. Small particulate inclusions (e.g. chopped nuts, chocolate pieces, or cereal crisps or combination thereof) may be present in the filled sandwich wafer product provided that the layer of confectionary material is thicker than the diameter of the particles.

### Effects of Invention

The present invention shows that the selection of a continuous fat phase having a specific fatty acid profile, e.g. by combining lauric fat with non-lauric fat, and the interesterification thereof, allows for a better aeration compared to lauric fats, as well as longer preservation of the light and airy texture that is desired in the aerated confectionary material of the invention.

When using non-palm compositions, the present inventors have found that a higher level of aeration (higher overrun) can be obtained. In addition, it was found that for the non-palm compositions according to the present invention, the post hardening effect (determined by the hardness increase between day 1 and day 21) is low which is advantageous.

One of the advantages of the present invention is that by using the present continuous fat phase having the specific fatty acid profile, compared to non-interesterified fat or e.g. fat compositions having a higher C12 content, the preservation of the light, aerated texture and low density are maintained over a long time.

### Examples

The present invention is exemplified by the following non-limiting examples 1-4 and a comparative example to clearly show the effects of the invention and show that one or more objects of the invention are obtained by the claimed aerated fat-based confectionary material.

### 1. Preparation of the Continuous Fat Phases

### 1.1 Fat Compositions

Several compositions of fats are prepared as shown in Table 1 below.

TABLE 1
composition of fats for examples

| Type of fat used: | | | | | |
|---|---|---|---|---|---|
| [in % by weight, based on the | Comp. | | | | |
| total weight of fat composition] | Ex. | Ex. 1 | Ex. 2 | Ex. 3 | Ex. 4 |
| Palm kernel oil | 100 | 65 | | | |
| Palm stearin | | 35 | | | |
| Palm oil | | | | 60 | |
| Cocoa butter | | | 45 | | 45 |
| Coconut oil | | | 55 | 40 | 40 |
| High-oleic sunflower oil | | | | | 15 |

### 1.2 Interesterification

The fat compositions of Examples 1 to 4 were subjected to a chemical interesterification process. Chemical interesterification is a process that is generally well known by the person skilled in the art. The fat composition of the comparative example was not subjected to an interesterification process.

### 1.3 Analysis of the Continuous Fat Phase

The continuous fat phase is the fat composition that is obtained after the steps of blending and interesterification (examples 1-4). For the comparative example, the continuous fat phase consists of the refined palm kernel oil as obtained. Table 2 below shows the analysis of the continuous fat phase in terms of fatty acid (FAC) profile, carbon numbers, and SFC profile. The measurements thereof are as discussed above, being FAME analysis using gas chromatography according to AOCS method Cel-62 for the FAC profile; AOCS Official Method Ce 5-86, using based on gas chromatography (GC), or Ce 5b-89 based on high-pressure liquid chromatography (HPLC) and by using AOCS Cd 16b-93 for the SFC profile.

TABLE 2
Analysis of continuous fat phases

| | | | | |
|---|---|---|---|---|
| Comp. Ex | Ex. 1 | Ex. 2 | Ex. 3 | Ex. 4 |

| Processing | |
|---|---|
| | Blending and chemical interesterification |
| n.a. | see point 1.2 |

FAC profile
[wt. % means % by weight, based on the total weight of C8-C24 fatty acids]

| | | | | | |
|---|---|---|---|---|---|
| C12 (wt. %) | 45.9 | 29.9 | 25.5 | 18.7 | 18.6 |
| C16 (wt. %) | 9.0 | 21.0 | 16.6 | 29.9 | 16.0 |
| C18 (wt. %) | 2.5 | 3.3 | 17.5 | 4.0 | 21.4 |
| C16 + C18 (wt. %) | 11.5 | 24.3 | 34.1 | 33.9 | 37.4 |
| C16/C18 (ratio) | 3.6 | 6.4 | 0.9 | 7.5 | 0.7 |
| C18.1 + C18.2 + | 19.3 | 29.6 | 21.7 | 32.6 | 29.9 |
| C18.3 (wt. %) | | | | | |

Carbon Number
[in % by weight based on the total weight of the triglycerides]

| | | | | | |
|---|---|---|---|---|---|
| CN42 + CN44 | 15.2 | 28.0 | 25.4 | 22.8 | 20.6 |
| CN46 | 4.8 | 14.0 | 12.1 | 15.3 | 12.2 |

SFC profile
[in % by weight based on the total weight of the continuous fat phase]

| | | | | | |
|---|---|---|---|---|---|
| SFC@10° C./N10 | 71.0 | 72.4 | 72.8 | 60.1 | 62.1 |
| SFC@20° C./N20 | 42.1 | 44.8 | 43.0 | 29.7 | 32.1 |
| SFC@25° C./N25 | 17.5 | 26.4 | 26.0 | 16.7 | 18.2 |
| SFC@30° C./N30 | 0.0 | 10.7 | 11.2 | 7.8 | 8.4 |
| SFC@35° C./N35 | 0.0 | 0.9 | 2.7 | 2.0 | 2.5 |
| SFC@40° C./N40 | 0.0 | 0.3 | 0.2 | 0.6 | 0.1 |
| N25 minus N30 | 17.5 | 15.7 | 14.8 | 8.9 | 9.8 |
| N20 minus N25 | 24.6 | 18.4 | 17.0 | 13.0 | 13.9 |

### 1.4 Recipe of the Fat-Based Confectionary Material

All of the continuous fat phases discussed above for Examples 1-4 and the comparative example were prepared into a fat-based confectionary material comprising a sweetener (in this case silk sugar) and an additional ingredient (in this case an emulsifier, being soy lecithin). The composition is as follows: 59.5% by weight of silk sugar, 40% by weight of the continuous fat phase, and 0.5% by weight of soy lecithin.

### 1.5 Preparation of the Aerated Fat-Based Confectionary Material—Using Press Whip

The preparation of the aerated fat-based confectionary materials according to the comparative example and examples 1-3 are carried out as follows. First, the continuous fat phase as discussed above and the silk sugar are mixed at a temperature between 45 to 53° C. Subsequently, soy lecithin is added to the mixture of fat and sweetener at the mentioned temperature range between 45 and 53° C. The resulting mixture is cooled in a Stephan mixer that is temperature controlled by means of a double wall cooled with water at 13 to 15° C. Temperature of the cooled mixtures are shown in table 3. The cooled mixtures are transferred from the Stephan mixer to the Press Whip (Ter Braak) that is temperature controlled by means of a double wall cooled with water at 13 to 15° C. The cooled mixture is aerated by mixing at high speed (220 rpm) and injecting air at a pressure of 1.5 bar. Temperature of the aerated product samples is shown in table 3.

TABLE 3
Temperature conditions during preparation
of aerated fat-based confectionary material

| | Comparative | Example | Example | Example |
|---|---|---|---|---|
| | example | 1 | 2 | 3 |
| T° after cooling in | 26.1° C. | 29.0° C. | 30.9° C. | 27.0° C. |
| Stephan mixer | | | | |
| T° after aeration in | 26.0° C. | Not | 30.3° C. | 28.5° C. |
| Press Whip | | available | | |

### 1.6 Results of Aeration

The results of the aeration process described in point 1.5 are tested by determining the overrun and by determining the increase in hardness, determined by measuring the hardness using a Texture analyzer with a cylindric probe on day 1 and day 21 after aeration (day 1 being the first day after aeration; samples stored at 18° C.) and by reviewing the increase in hardness observed. The results are shown in Table 4 below.

TABLE 4
Analysis of aerated fat-based confectionary materials

| | Comparative | Example | Example | Example |
|---|---|---|---|---|
| | example | 1 | 2 | 3 |
| weight before aeration | 379.1 g | 388.0 g | 381.3 g | 377.3 g |
| weight after aeration | 269.8 g | 250.0 g | 232.0 g | 236.2 g |
| OR % | 41% | 55% | 64% | 59% |

The samples before and after aeration where each individually provided in a recipient having the same fixed volume, and were weighed at a temperature of 20° C. and at atmospheric pressure.

The claimed range for the overrun (OR %) in from 30 to 90%, preferably from 45 to 85%, more preferably from 50 to 80%. The data above clearly shows that the comparative example has a too low value for all of the preferred overrun ranges (41%) so that aeration is not optimal. The Examples 1-3 according to the invention all have values that are within the claimed range as well as in all of the preferred ranges.

### 1.7 Preparation of the Aerated Fat-Based Confectionary Material—Using Hansa Mixer

The preparation of the aerated fat-based confectionary material according to example 4 is carried out as follows. First, the continuous fat phase as discussed above and the silk sugar are mixed at a temperature of 42.3° C. Soy lecithin is added. Subsequently the mixture is aerated in a Hansa mixer with speed setting of mixing head at 222, pump setting at 56, pre-pressure of 6 bar, system pressure of 1.5 to 2.0 bar, back pressure of 1.0 to 2.0 bar and air flow for of 6 1/min. The settings allow to cool and crystallize the fat and homogenously distribute the air bubbles into the fat phase. The resulting aerated product has a temperature of 27,8° C., an overrun of 78% (weight of material before aeration=387.1 g, and weight of material after aeration=217.2 g, using the same method as described above) and a hardness increase between day 1 and day 21 of 45% [day 1=417 gram, day 21=606 gram].

1. Aerated fat-based confectionary material comprising a fat phase, a sweetener, and optionally water, wherein the fat phase is the continuous phase having:
a content of lauric acid (C12) in a range of from 10 to 35% by weight based on the total weight of C8-C24 fatty acids;
a content of palmitic acid and stearic acid (C16+C18) in a range of from 20 to 50% by weight based on the total weight of C8-C24 fatty acids,
a content of triglycerides with a carbon number of 46 (CN46) of from 8 to 16% by weight based on the total weight of the triglycerides; and
a content of triglycerides with a carbon number of 42 and 44 (CN42+CN44) of from 13 to 28% by weight based on the total weight of the triglycerides.

2. The aerated fat-based confectionary material according to claim 1, wherein the aerated fat-based confectionary material has an overrun (OR %) in a range of from 30 to 900%.

3. The aerated fat-based confectionary material according to claim 1, wherein the continuous fat phase has a content of unsaturated C18 fatty acids in a range of from 15 to 40% by weight based on the total weight of C8-C24 fatty acids.

4. The aerated fat-based confectionary material according to claim 1, wherein the continuous fat phase has a ratio of palmitic acid over stearic acid (C16/C18) of maximally 1.2 and/or a ratio of palmitic acid over stearic acid (C16/C18) of minimally 0.5.

5. The aerated fat-based confectionary material according to claim 1, wherein the continuous fat phase comprises at least one chemically or enzymatically interesterified fat.

6. The aerated fat-based confectionary material according to claim 1, wherein the continuous fat phase consists of non-hydrogenated fats.

7. The aerated fat-based confectionary material according to claim 1, comprising from 25 to 80% by weight of the continuous fat phase and from 30 to 75% by weight of the sweetener, based on the weight of the aerated fat-based confectionary material.

8. The aerated fat-based confectionary material according to claim 1, further comprising at most 20% by weight of an aqueous solution or dispersion based on the weight of the aerated fat-based confectionary material.

9. The aerated fat-based confectionary material according to claim 1, wherein the aerated fat-based confectionary material further comprises an additional ingredient, selected from the group consisting of milk ingredients, milk alternative ingredients, egg ingredients, cocoa ingredients, fruit ingredients, coffee powder, nut paste, natural colorants, synthetic colorants, salt, antioxidants, emulsifiers, natural flavors, synthetic flavors, and a combination of two of more thereof.

10. The aerated fat-based confectionary material according to claim 1, wherein the aerated fat-based confectionary material is substantially free of water and/or emulsifiers.

11. Aerated fat-based confectionary material according to claim 1, comprising:
a) from 40 to 70% by weight of the continuous fat phase;
b) from 20 to 50% by weight of a sweetener;
c) from 0.5 to 8% by weight of an aqueous solution or dispersions; and
d) from 0.3 to 1.0% by weight of lecithin;
wherein the amounts are based on the weight of the aerated fat-based confectionary material; and
wherein said aerated fat-based confectionary material has an overrun (OR %) in a range of from 30 to 90.

12. Method of preparing an aerated fat-based confectionary material, comprising the steps of
i) providing a continuous fat phase having:
a content of lauric acid (C12) in a range of from 10 to 35% by weight based on the total weight of C8-C24 fatty acids;
a content of palmitic acid and stearic acid (C16+C18) in a range of from 20 to 50% by weight based on the total weight of C8-C24 fatty acids,
a content of triglycerides with a carbon number of 46 (CN46) of from 8 to 16% by weight based on the total weight of the triglycerides;
a content of triglycerides with a carbon number of 42 and 44 (CN42+CN4) of from 13 to 28% by weight based on the total weight of the triglycerides;
ii) mixing said continuous fat phase with a sweetener and optionally one or more additional ingredients;
iii) cooling and aerating said mixture obtained in step ii) so that an aerated fat-based confectionary material is obtained.

13. The method according to claim 12, wherein in step iii) an aerated fat-based confectionary material is obtained having an overrun (OR %) in a range of from 30 to 90%.

14. A confectionary product comprising the aerated fat-based confectionary material according to claim 1 or prepared according to the method of claim 12.

15. The confectionary product according to claim 14, wherein said confectionary product is selected from the group consisting of biscuits, cakes and cupcakes, sandwich cookies, wafers, chocolates tablets, fondants, truffles, caramels and pralines.
